(19) United States
(12) Patent Application Publication
(10) Pub. No.: US 2020/0298721 A1
(43) Pub. Date: Sep. 24, 2020

(54) CONTROL DEVICE AND COMPUTER-READABLE STORAGE MEDIUM

(71) Applicant: HONDA MOTOR CO.,LTD., Tokyo (JP)

(72) Inventors: Motoki HISHIDA, Saitama (JP); Hiroyuki KANAZAWA, Saitama (JP); Hakaru SADANO, Saitama (JP)

(21) Appl. No.: 16/817,651

(22) Filed: Mar. 13, 2020

(30) Foreign Application Priority Data
Mar. 20, 2019 (JP) 2019-052111

(51) Int. Cl. B60L 53/60; H04W 4/021; H02J 7/00; G06Q 50/06

(52) U.S. Cl. CPC B60L 53/60; H04W 4/021; B60L 50/60; G06Q 50/06; H02J 7/00032

(57) ABSTRACT

A control device includes: a behavioral area identification unit for identifying a behavioral area of a user of a vehicle equipped with an electric power source for driving; and a notification control unit for making the user notified power transmission and reception information indicating past performance of power transmission and reception performed between the vehicle associated with another user within the area indicated by area information and a power grid. A program causes a computer to function as the control device.

The contents of the following Japanese patent application are incorporated herein by reference: Japanese Patent Application 2019-052111 filed on Mar. 20, 2019.

### BACKGROUND

### 1. Technical Field

The present invention relates to a control device and a computer-readable storage medium.

### 2. Related Art

A power management device is known, for receiving an instruction of selecting any mode of a first mode of supplying in preference an outside of a mobile object with generated power of the power generator and a second mode of charging in preference the generated power of the power generator into an electricity storage device; and changing a supply destination of the generated power of the power generator according to the instruction (refer to, for example, Patent Literature 1 below and so on).

### REFERENCES IN THE PRIOR ART

### Patent Literatures

[Patent Literature 1] Japanese Unexamined Patent Application Publication No. 2015-216836
[Patent Literature 2] Japanese Patent No. 5395764

### SUMMARY

### Technical Problem

Conventionally, there has been a problem that information for a user to determine whether enabling a vehicle to transmit and receive power between the vehicle and a power grid is not sufficient.

### BRIEF DESCRIPTION OF THE DRAWINGS

FIG. 1 schematically illustrates a basic configuration of a power transmission and reception system 100.

FIG. 2 schematically illustrates a functional configuration of a management server 40.

FIG. 3 illustrates in a form of table an example of traveling record information of a vehicle 30.

FIG. 4 illustrates in a form of table an example of power transmission and reception performance information.

FIG. 5 illustrates in a form of table an example of connection status information.

FIG. 6 illustrates in a form of table an example of power trading information.

FIG. 7 illustrates in a form of table an example of weather information.

FIG. 8 illustrates in a form of table an example of event information.

FIG. 9 illustrates an example of a screen 900 for displaying power transmission and reception information on a map displayed on a user terminal 82.

FIG. 10 illustrates an example of a screen 1000 for displaying a predicted consideration value on the day.

FIG. 11 is a flow chart illustrating processes for a management server 40 to generate predicted power transmission and reception information.

FIG. 12 illustrates an example of a screen 1200 displayed when a user 80 searches for a destination by keyword searching.

FIG. 13 illustrates an example of a computer 2000 in which a plurality of embodiments of the present invention may be entirely or partially embodied.

### DETAILED DESCRIPTION OF THE INVENTION

While the following describes the present invention through embodiments of the invention, the below embodiments do not limit the invention according to the claims. Also, not all the combinations of features described in the embodiments are essential for solutions of the invention. Note that, in the drawings, identical or similar portions are given identical reference numerals, and repeated descriptions may be omitted.

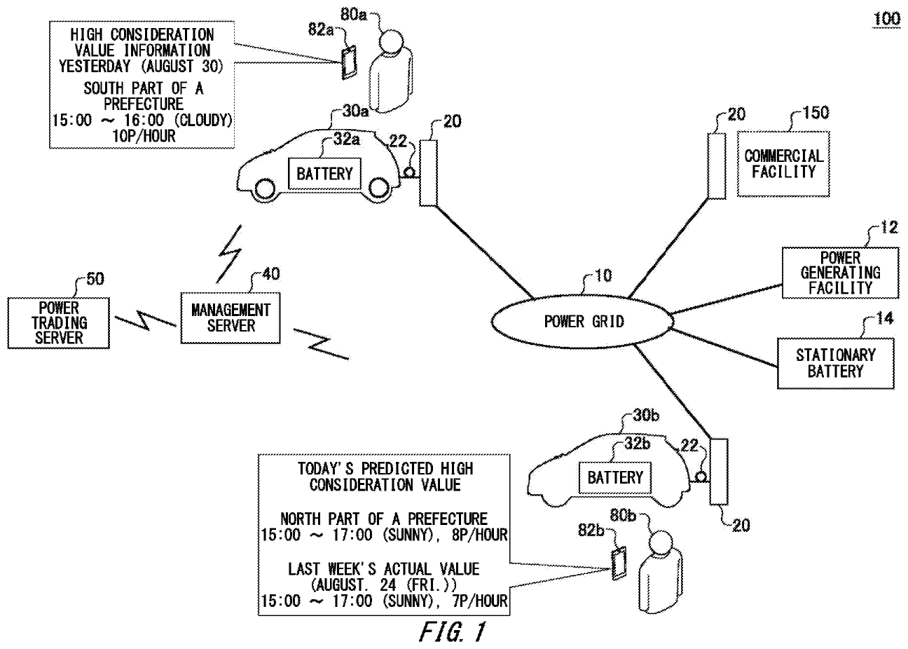

FIG. 1 schematically illustrates a basic configuration of a power transmission and reception system 100. The power transmission and reception system 100 is a system for performing V2G (Vehicle-to-Grid) that a power aggregator interchanges power between a vehicle and a power grid, for example, using a battery included in the vehicle. The power transmission and reception system 100 has a function to effectively inform a user that it is in a place where the power transmission and reception between the vehicle and the power grid is possible. Note that performing by the vehicle at least any of releasing power to the power grid and receiving power from the power grid is referred to as V2G.

The power transmission and reception system 100 includes: a plurality of vehicles including a vehicle 30a and a vehicle 30b; a stationary battery 14; a plurality of charging and discharging facilities 20; a management server 40; power generating facility 12; and a plurality of user terminals including a user terminal 82a and a user terminal 82b.

A user 80a and a user 80b are users of the power transmission and reception system 100. In particular, the user 80a is a user of the vehicle 30a, and the user 80b is a user of the vehicle 30b. Note that a user of a vehicle may be any person associated with the vehicle, such as the owner of the vehicle or a family member of the owner. In this embodiment, respective users of the user 80a and the user 80b may be collectively referred to as “user 80”.

The user terminal 82a is a communication terminal for the user 80a to use. The user terminal 82b is a communication terminal for the user 80b to use. A plurality of user terminals including the user terminal 82a and the user terminal 82b may be collectively referred to as “user terminal 82”.

The user terminal 82 may be, for example, a mobile terminal, a personal computer, vehicle navigation device, or the like. The mobile terminal can be exemplified as a mobile phone, a smartphone, a PDA, a tablet, a notebook computer, a laptop computer, a wearable computer, etc.

The vehicle 30a includes a battery 32a. The vehicle 30b includes a battery 32b. In this embodiment, a plurality of vehicles including the vehicle 30a and the vehicle 30b may be collectively referred to as “vehicle 30”. Also, a plurality of batteries including the battery 32a and the battery 32b may be collectively referred to as “battery 32”. The battery 32 may be a various secondary batteries, such as a lithium-ion battery or a nickel-hydrogen battery.

Note that the battery 32 is an example of an electric power source for driving of the vehicle 30. The electric power source for driving includes an electric power source generating electric energy to be provided to a power source of the vehicle 30 by consuming fuel, like a fuel-cell etc. The fuel may be hydrocarbon fuel such as hydrogen, gasoline, light oil, and natural gas, alcohol fuel, or the like. The electric power source for driving may be any electric power source that can generate electric energy to be provided to the power source of the vehicle 30.

The vehicle 30 is an example of transport equipment. The vehicle 30 is a vehicle equipped with a power source driven by electric energy, for example, an electric vehicle, a fuel-cell vehicle (FCV), etc. The electric vehicle includes a battery electric vehicle (BEV) and a hybrid vehicle or plug-in hybrid electric vehicle (PHEV) with an internal-combustion engine providing at least a part of driving power. In this embodiment, the vehicle 30 is an electric vehicle with the battery 32 as an electric power source for driving. In a form of adopting the battery as the electric power source for driving, discharge of the battery corresponds to releasing energy from the electric power source for driving, and charge of the battery corresponds to storing energy into the electric power source for driving.

The management server 40 is capable to communicate with the vehicle 30, the stationary battery 14, and the user terminal 82 through a communication network. The management server 40 is also capable to communicate with a power trading server 50 through the communication network. The communication network may include a transmission channel for a wired communication or a wireless communication. The communication network may include a communication system including the internet, the P2P network, a dedicated line, the VPN, a power line communication line, a mobile phone line, and the like.

The power grid 10 may include transmission system or a distribution system of the power system and a distribution network of a power grid. The vehicle 30, the stationary battery 14, the charging and discharging facility 20, and the power generating facility 12 are connected to the power grid 10. The power grid 10 may be provided for each region. The power grid 10 may be a micro-grid. The power grid 10 may be any scale of distribution network connecting power equipment consuming power and an electric power source. For example, the power grid 10 may be a distribution network provided to any facility such as a commercial facility 150. The power grid 10 may be provided for each building. The charging and discharging facility 20, the stationary battery 14, and the power generating facility 12 are capable of performing power transmission and reception between the power grids 10. The charging and discharging facility 20 is an example of a power transmission and reception facility for performing power transmission and reception between the vehicle 30 and the power grid 10.

The power generating facility 12 is managed by an electric power company or the like. The charging and discharging facility 20 includes, for example, a charging and discharging device installed in a house and a charging and discharging stand installed in an apartment building, a parking area of a building or the commercial facility 150, a public space, or the like.

The vehicle 30 is connected to the charging and discharging facility 20 through a charging and discharging cable 22. That is, the vehicle 30 is connected to the power grid 10 through the charging and discharging cable 22 and the charging and discharging facility 20. The vehicle 30 performs power transmission and reception between the battery 32 and the power grid 10 through the charging and discharging facility 20. For example, the vehicle 30 releases power obtained by discharging the battery 32 to the power grid 10 through the charging and discharging cable 22 and the charging and discharging facility 20. Also, the vehicle 30 charges the battery 32 by power supplied from the power grid 10 through the charging and discharging cable 22 and the charging and discharging facility 20. Note that power transmission and reception to and from the power grid 10 may be referred to as “power transmission and reception with the power grid 10” etc. Also, to enable the vehicle 30 to transmit and receive power to and from the power grid 10 by connecting the vehicle 30 to the charging and discharging facility 20, and so on, may be referred to as “V2G connection”, etc.

The stationary battery 14 is managed by the power aggregator. The battery 32 in the vehicle 30 forms a virtual power plant with the stationary battery 14. The management server 40 is managed by the power aggregator. The management server 40 controls power transmission and reception between the battery 32 and the power grid 10, and between the stationary battery 14 and the power grid 10.

The management server 40 performs power trading by bidding in a wholesale power market. The power trading server 50 is managed by an operator of the wholesale power market. The management server 40 bids for the power trading server 50 in time units of 30-minute as one time frame. The management server 40 discharges based on a contract result, the battery 32 and the stationary battery 14 in each time frame to supply power to the power grid 10.

For example, the management server 40, discharge, according to the contract quantity for bidding of the power aggregator in the wholesale power market, the battery 32 and the stationary battery 14 to supply, to the power grid 10, the released power from the battery 32 and the stationary battery 14. Also, the management server 40 controls charging and discharging of the battery 32 and the stationary battery 14 in a range of adjusting capability contracted for the bid of the power aggregator in a demand and supply adjustment market, to adjust the power supply and demand in the power grid 10. For example, the management server 40 controls charging and discharging of the battery 32 and the stationary battery 14, according to, from power transmission and distribution operators and retail electricity suppliers, an up demand response (up DR), a down demand response (down DR), and an up-and-down demand response (up-and-down DR).

Specifically, according to the up DR and by controlling at least one of the vehicle 30 and the charging and discharging facility 20, the management server 40 causes the battery 32 in the vehicle 30 to be charged with power received from the power grid 10 through the charging and discharging facility 20. Also, according to the down DR and by controlling at least one of the vehicle 30 and the charging and discharging facility 20, the management server 40 reduces the charging amount of the battery 32 in the vehicle 30 or discharges the battery 32 in the vehicle 30, to reduce, as a whole, the power transmission amount from the power grid 10 to the vehicle 30 or to release power obtained by discharging the battery 32 towards the power grid 10 through the charging and discharging facility 20.

In this embodiment, the management server 40 notifies the user 80 of information indicating a consideration value given to another user 80 by performing the V2G connection in past. For example, when the user 80a and the vehicle 30a were located in the south of A prefecture during the time zone between 15:00 and 16:00 on August 30, and the vehicle 30a was not in the V2G connection during that time zone, “10p/hour” is notified on the next day as a consideration value obtained assuming that the vehicle 30a was in the V2G connection during that time zone. “10p” is a performance value of a consideration value per unit time obtained by another user 80 if vehicle was in the V2G connection during that time zone. This enables the user 80 to know that the user 80 should have obtained high profit if the user 80 had performed the V2G connection between 15:00 and 16:00 on the previous day.

Also, like notification information to the user 80b shown in FIG. 1, “8p” is notified the user 80b located in the north of A prefecture, as a predicted consideration value per unit time obtained when the V2G connection is performed in the north of A prefecture between 15:00 and 17:00 on the day. At the time, if the weather information on August 24 of the same day in the previous week is similar to the weather information on the day, the management server 40 obtains the consideration value per unit time of “7p” that was given to another user 80 who connected to the power grid 10 on August 24, then to notify it as a performance value of the consideration value. This enables the user 80b to know to have possibilities to obtain high profit by performing the V2G connection between 15:00 and 17:00 today.

In this way, the management server 40 notifies the user 80 of performance information of a consideration value obtained when the V2G connection is performed. By repeatedly receiving this notification, the user 80 can learn what weather condition or time zone leads to high consideration value. This enables the user 80 to be prompted to perform the V2G connection when power demand by the V2G is high. This leads to being easy for the power aggregator to secure capacity capable of transmitting and receiving power between the vehicle 30 and the power grid 10. In turn, this contributes to stabilizing power supply and demand in the power grid 10.

Note that, in this embodiment, the consideration value given to the user 80 when the V2G connection has performed is represented as a unit that is a percentage of a reference capacity of the battery 32. The reference capacity may be a fixed value uniformly defined across all the users 80. The reference capacity may be defined for each user 80 or for each vehicle 30. For example, the reference capacity may be the full-charged capacity of each battery 32 in the vehicles 30. When the remaining capacity of the battery 32 increases by performing the V2G connection, the consideration value is a percentage of the increased remaining capacity to the reference capacity. When the user 80 is given monetary compensation by connecting the vehicle 30 to the power grid 10, the consideration value is a value obtained by dividing the amount of monetary compensation by a charging unit price of the battery 32. When the remaining capacity of the battery 32 decreases by performing the V2G connection while the user 80 is given the monetary compensation, the consideration value is a value obtained by subtracting a percentage of the decreased remaining capacity to the reference capacity from the value obtained by dividing the amount of monetary compensation by the charging unit price of the battery 32.

Note that in this embodiment, power transmission and reception means that power transmission and reception occurs from at least one of the vehicle 30 and the power grid 10 to another. For example, power transmission and reception may mean releasing power from the vehicle 30 towards the power grid 10. Also, power transmission and reception may mean that power transmission from the power grid 10 towards the vehicle 30 is performed. Note that in a case where the vehicle 30 releases power through the charging and discharging device installed at a power consumer side such as the home of the user, when consumption power at the power consumer side is larger than power released from the vehicle 30, a net power supply to the power grid 10 does not occur at a connection point between the power consumer side and the power grid 10, and the power supply amount from the connection point to the power consumer side may merely decrease. Even in this case, seen from the power grid 10, it can be considered that power transmission and reception to and from outside of the power grid 10 occurred. Thus, in this embodiment, it does not matter whether or not the power grid 10 receives a net power from a specific connection point between the power grid 10 and the vehicle 30 in power transmission and reception with the power grid 10 in the case that the vehicle 30 releases power.

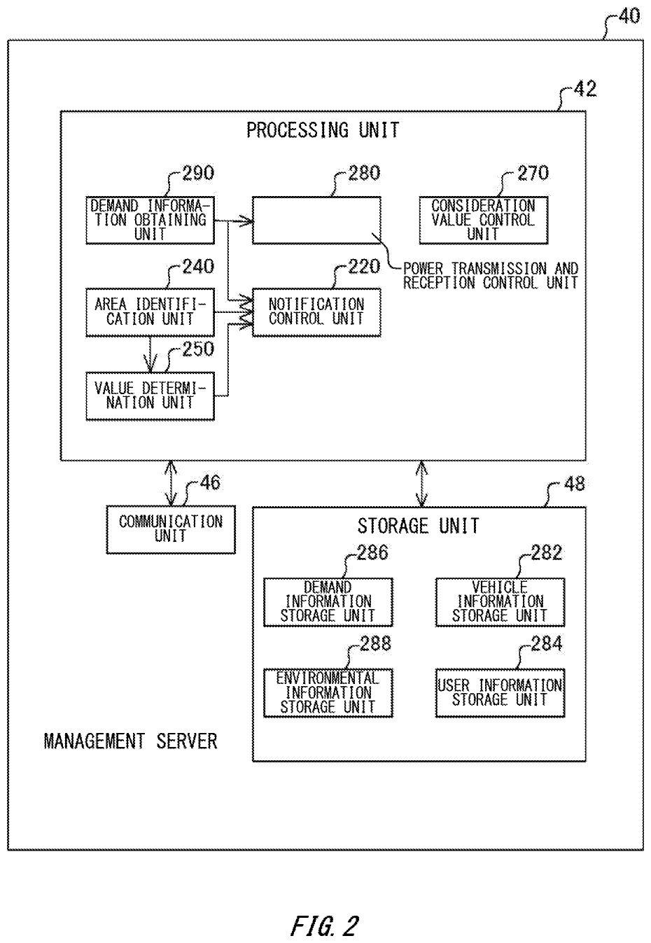

FIG. 2 schematically illustrates a functional configuration of the management server 40. The management server 40 includes a processing unit 42, a storage unit 48, and communication unit 46.

The processing unit 42 is implemented by the processing device including a processor. The storage unit 48 is implemented by a non-volatile memory device. The processing unit 42 performs various processes by using information stored in the storage unit 48.

The communication unit 46 is responsible for communicating between the vehicle 30, the stationary battery 14, the user terminal 82, and the power trading server 50. Information that the communication unit 46 receives from the vehicle 30, the stationary battery 14, the user terminal 82 and the power trading server 50 is supplied to the processing unit 42. Also, information to be transmitted to the vehicle 30, the stationary battery 14, the user terminal 82, and the power trading server 50 is generated by the processing unit 42 and transmitted via the communication unit 46.

The management server 40 serves as a control device. The management server 40 may be a system implemented by a single information processing device or may be a system implemented by a plurality of information processing devices.

The processing unit 42 includes a notification control unit 220, an area identification unit 240, a consideration value control unit 270, a power transmission and reception control unit 280, and demand information obtaining unit 290. The storage unit 48 includes a vehicle information storage unit 282, a user information storage unit 284, a demand information storage unit 286, and an environmental information storage unit 288.

The area identification unit 240 identifies a behavioral area of the user 80 associated with the vehicle 30 with electric power source for driving. For example, the area identification unit 240 may identify the behavioral area based on at least any of traveling records of the vehicle 30, destination information specified by the user 80, preference information of the user 80, keyword information inputted by the user 80, a position of the user 80 or the vehicle 30, and a home location of the user 80.

The traveling record information of the vehicle 30 may be stored in the vehicle information storage unit 282, in association with the identification information of the vehicle 30. The preference information of the user 80 may be stored in the user information storage unit 284, in association with the identification information of the user 80. The preference information of the user 80 may be pre-registered by the user 80. The preference information of the user 80 may be dynamically generated based on records of the keyword information inputted by the user 80. The preference information of the user 80 may be a keyword itself. The area identification unit 240 may identify, as the behavioral area of the user 80, an area associated with a keyword as preference information of the user 80.

The notification control unit 220 makes the user 80 notified power transmission and reception information that indicates performances of power transmission and reception performed in past between the vehicle 30 associated with another user 80 in the behavioral area and the power grid 10. The power transmission and reception information may include information that indicates a value of the power transmission and reception. The power transmission and reception information may include information that indicates a period when the power transmission and reception were performed. Note that power transmission and reception record information between the power grid 10 and the vehicle 30 may be stored in the vehicle information storage unit 282. The notification control unit 220 may obtain the power transmission and reception information based on the power transmission and reception record information to be stored in the vehicle information storage unit 282.

The notification control unit 220 may make the user 80 notified on condition that the value of the power transmission and reception is higher than a predetermined value. The notification control unit 220 may make the user 80 notified, on condition that, during a period when the user 80 did not enable the vehicle 30 to perform the power transmission and reception to and from the power grid 10, the value of the power transmission and reception in an area where the vehicle 30 was located is higher than the predetermined value.

The information indicating the value of the power transmission and reception may be information indicating a consideration value provided to another user 80 or the vehicle 30 associated with another user 80 for having performed the power transmission and reception. Information indicating the value of the power transmission and reception information may be information indicating an excess or deficiency, to the power demand amount of the power grid 10, of the quantity of the vehicle 30 connected so as to be capable of transmitting and receiving power to and from the power grid 10. The information indicating the value of the power transmission and reception may be information indicating the connection status, to the power demand amount of the power grid 10, of the vehicle 30 connected so as to be capable of transmitting and receiving power to and from the power grid 10. The information indicating the value of the power transmission and reception may be information indicating a ratio, to the power demand amount of the power grid 10, of a total number of the vehicles 30 that was capable of transmitting and receiving power to and from the power grid 10. The information indicating the value of the power transmission and reception may be information indicating a ratio, to the power demand amount of the power grid 10, of a total value of the amount of power capable of being transmitted and received to and from the power grid 10 by the vehicle 30 that was capable of transmitting and receiving power to and from the power grid 10. Note that information indicating a consideration value by using information indicating a consideration value provided to the user 80 or the vehicle 30 associated with another user 80 may be stored being included in the power transmission and reception record information to be stored in the vehicle information storage unit 282. Also, the power demand amount of the power grid 10, the number of vehicles 30 that were capable of transmitting and receiving power to and from the power grid 10, and the information indicating the amount of power capable of transmitting and receiving power between the vehicles 30 and the power grid 10 may be stored in the demand information storage unit 286.

The notification control unit 220 may make the power transmission and reception information displayed on the user terminal 82 used by the user 80 along with a position on the map of the behavioral area in which the power transmission and reception were performed. For example, when the user terminal 82 is a vehicle navigation device of the vehicle 30, the notification control unit 220 may make an object indicating power transmission and reception information overlaid and displayed on the map displayed on the screen of the vehicle navigation device.

The environmental information storage unit 288 of the storage unit 48 stores the environmental information of the behavioral area when the power transmission and reception were performed. The environmental information of the behavioral area when the power transmission and reception were performed includes information indicating at least any of weather in the behavioral area when the power transmission and reception were performed and an event held in the behavioral area when the power transmission and reception were performed.

The value determination unit 250 determines a value in performing power transmission and reception between the vehicle 30 associated with the user 80, currently or in future, in the behavioral area and the power grid 10, based on the environmental information of the behavioral area when the power transmission and reception were performed and the environmental information, currently or in future, in the behavioral area. The notification control unit 220 may make the user 80 notified the information indicating a value determined by the value determination unit 250. The notification control unit 220 may make the user 80 notified the information indicating the power transmission and reception information and the value, on condition that the value determined by the value determination unit 250 is higher than the predetermined value.

The demand information obtaining unit 290 obtains information indicating power demand in the power grid 10. The information indicating power demand may include the information indicating the power demand amount in the power grid 10, information indicating power supply amount from the power generating facility 12, information indicating demand-and-supply balance of power in the power grid 10, and the like. The information indicating the power demand may include information indicating an adjusting capability in the power grid 10.

The contract quantity in the power trading described above is an example of information indicating the power demand. The information indicating the power demand may be a contract price in the power trading, or a contract category showing whether it is a buying contract or a selling contract. Also, the information indicating the power demand may be information indicating a real-time imbalance quantity between supply and demand in the power grid 10, or may be information indicating a predicted value of an imbalance quantity between supply and demand in future. The information indicating the power demand may be information indicating a real-time consumption power amount of the power consumer of the power grid 10 or indicating a predicted value of the consumption power. As the information indicating the power demand, not only the amount of power itself, but also a variety of information directly or indirectly impacting the power demand, such as temperature information, humidity information, weather information, event information, and the like are applicable.

Note that the power trading market may exemplified as the day-ahead market, the intra-day market, the power demand and supply balancing market, and the like. As trading forms of the power trading, a variety of trading forms other than the trading form of these power trading markets are applicable.

The power transmission and reception control unit 280 makes the vehicle 30 perform the power transmission and reception to and from the power grid 10, depending on power demand in the power grid 10. The power transmission and reception control unit 280 communicates with the ECU of the vehicle 30 to sequentially obtain information on possibility of power transmission and reception indicating whether the vehicle 30 is connected to the charging and discharging facility 20 capable of performing power transmission and reception to and from the power grid 10. When it is possible for the vehicle 30 to perform the power transmission and reception to and from power grid 10, the power transmission and reception control unit 280 instruct the ECU included in the vehicle 30 to charge and discharge the battery 32, depending on power demand obtained by the demand information obtaining unit 290. The ECU of the vehicle 30, according to the instruction from the power transmission and reception control unit 280, communicates with the charging and discharging facility 20, and controls a power converter of the vehicle 30 to charge the battery 32 through the charging and discharging facility 20 or release power obtained by discharging the battery 32. Note that the power transmission and reception control unit 280 may sequentially obtain, from the ECU of the vehicle 30, information indicating: an amount of input power from the charging and discharging facility 20 to the power converter in charging the battery 32; an amount of output power from the power converter to the charging and discharging facility 20 in discharging the battery 32; and the SOC (State of Charging) of the battery 32. The power transmission and reception control unit 280 may control the power transmission and reception between the vehicle 30 and the power grid 10, based on the information obtained from the ECU of the vehicle 30.

The consideration value control unit 270 generates consideration value information indicating a consideration value given to the user 80 of the vehicle 30 if the vehicle 30 and the charging and discharging facility 20 are connected. The consideration value information indicates the consideration value against a fact that the vehicle 30 and the charging and discharging facility 20 are connected. The consideration value information may be information indicating a monetary value. The consideration value information, for example, may be a point or the like.

According to the management server 40, information for determining whether the user 80 connects the vehicle 30 to the charging and discharging facility 20 can be provided to the user 80. This enables user 80 to connect the vehicle 30 to the charging and discharging facility 20 in an effective time zone, for example, a time zone when there are lots of power selling demand and power purchase demand, etc.

Note that at least a part of the function of the management server 40 described in this embodiment may be implemented by a combination between the management server 40 and the ECU of the vehicle 30. For example, a function of at least a part of a process performed by the management server 40 in this embodiment may be performed by the ECU of the vehicle 30. For example, at least a part of processes performed by the demand information obtaining unit 290, the power transmission and reception control unit 280, the consideration value control unit 270, the area identification unit 240, the value determination unit 250, and notification control unit 220 may be performed by the ECU of the vehicle 30.

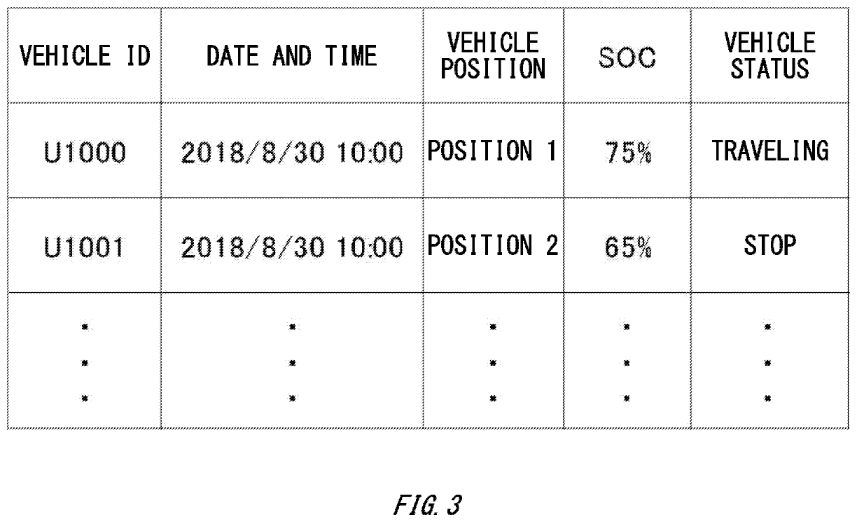

FIG. 3 illustrates in a form of table an example of traveling record information of a vehicle 30. The traveling record information is stored in the vehicle information storage unit 282. The traveling record information associates a vehicle ID, a date and time, a vehicle position, the SOC, and a vehicle state with each other.

In the vehicle ID, identification information of the vehicle 30 is stored. In the date and time, a time or a time period when vehicle data including the vehicle position, the SOC, and the vehicle state were obtained by the ECU of the vehicle 30 is stored. In the vehicle position, positional information indicating a position of the vehicle 30 is stored. The positional information may be any information capable of identifying the position of the vehicle 30, such as identification information of the charging and discharging facility 20 connected by the vehicle 30, and information indicating whether the vehicle 30 is located at home, in addition to geographical information such as latitude and longitude information.

In the SOC, an SOC of the battery 32 is stored. In the vehicle state, a state of the vehicle 30 is stored. The state of the vehicle 30 may include stop, travelling start, travelling, charging start, charging, charging complete, and the like. The management server 40 may sequentially receive the vehicle data obtained by the ECU of the vehicle 30 from the ECU of the vehicle 30 to generate traveling record information based on the received vehicle data.

In the management server 40, the area identification unit 240 identifies a traveling area where the vehicle 30 frequently traveled in past, based on the traveling record information. The area identification unit 240 identifies that traveling area as one of behavioral areas of the user 80 associated with the vehicle 30.

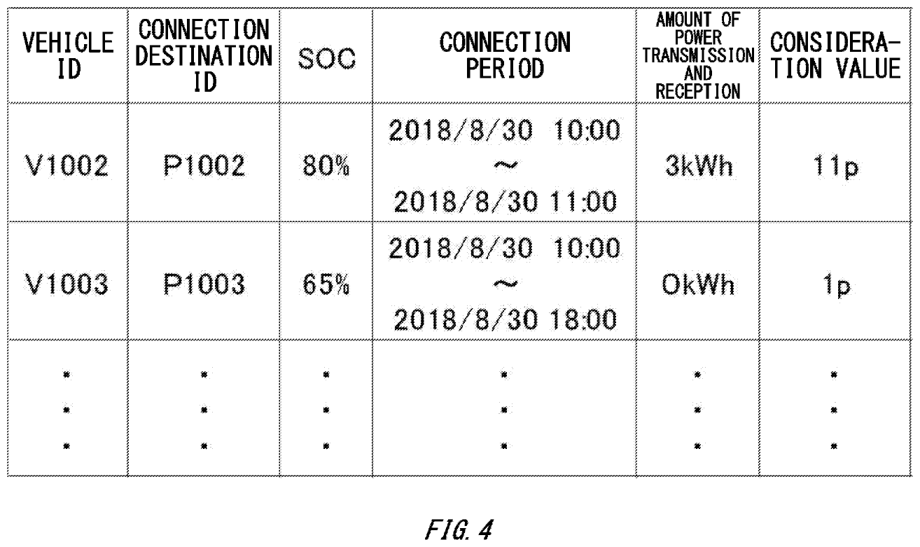

FIG. 4 illustrates in a form of table an example of power transmission and reception record information. The power transmission and reception record information is stored in the vehicle information storage unit 282. The power transmission and reception record information associates the vehicle ID, a connection destination ID, a connection period, the SOC, an amount of power transmission and reception, and a consideration value with each other.

In the vehicle ID, identification information of the vehicle 30 is stored. In the connection destination ID, identification information of the charging and discharging facility 20 is stored. In the SOC, information indicating an SOC of the battery 32 when the vehicle 30 is connected to the charging and discharging facility 20 is stored.

In the connection period, information indicating a period in which the vehicle 30 had been connected to the charging and discharging facility 20 is stored. The starting day and time of the connection period may be a date and time when the power transmission and reception control unit 280 becomes capable of controlling charge and discharge of the battery 32 after the charging and discharging cable 22 is fitted to the vehicle 30 and the charging and discharging facility 20. The ending day and time of the connection period may be an ending day and time of a period when the vehicle 30 had been connected to the charging and discharging facility 20 through the charging and discharging cable 22. In the ending day and time of the connection period, a date and time when the power cable was removed from at least one of the vehicle 30 and the charging and discharging facility 20 may be stored. The ending day and time of the connection period may be identified based on the information on possibility of power transmission and reception periodically transmitted from the charging and discharging ECU of the vehicle 30 to the management server 40. In the connection ending time, a date and time when it became impossible for the power transmission and reception control unit 280 to control charge and discharge of the battery 32 may be stored.

In the amount of power transmission and reception, a net amount of power transmitted and received between the vehicle 30 and the charging and discharging facility 20 within a connection period is stored. The amount of power transmission and reception may be a value per 30-minute of the amount of power transmitted between the vehicle 30 and the charging and discharging facility 20. Note that when the net power is supplied from the charging and discharging facility 20 to the vehicle 30, a positive value is stored in the amount of power transmission and reception, while when the net power is supplied from the vehicle 30 to the charging and discharging facility 20, a negative value is stored in the amount of power transmission and reception.

In the consideration value, information indicating a consideration value determined by the consideration value control unit 270 is stored. The consideration value given to the user 80 may be a total value of a pay-per-use consideration value given depending on the amount of power transmission and reception, and a basic consideration value given to the fact that the vehicle 30 has been connected to the charging and discharging facility 20. Even if the power transmission and reception is not performed between the vehicle 30 and the power grid 10, connecting the vehicle 30 to the charging and discharging facility 20 gives the basic consideration value to the user 80. The consideration value given to the user 80 may be offset by a fee in charging the battery 32 of the vehicle 30 with the charging and discharging facility 20.

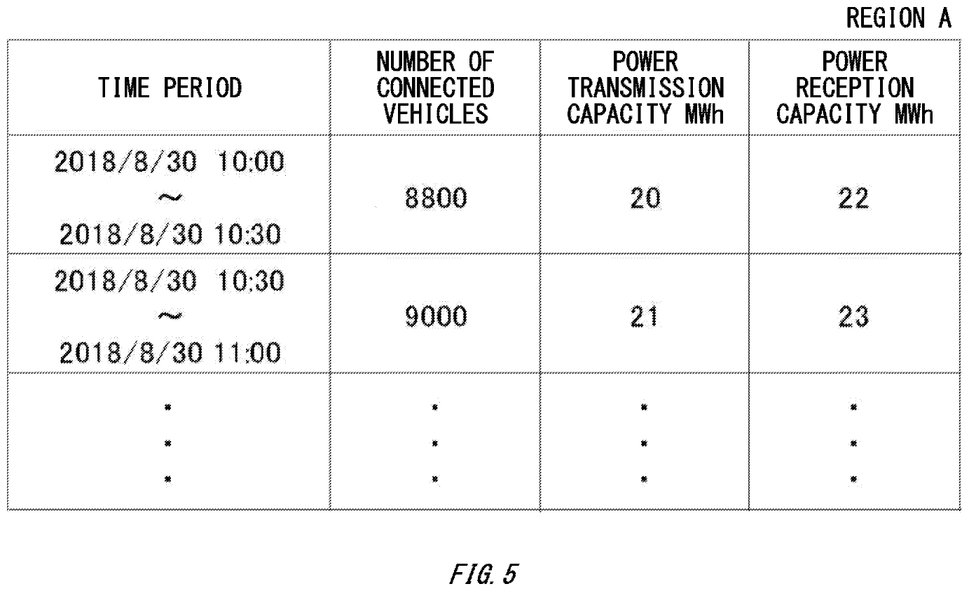

FIG. 5 illustrates in a form of table an example of connection status information. The connection status information is stored in demand information storage unit 286. In the connection status information, statistical information on the vehicle 30 being in the V2G connection is stored. The connection status information associates a period, the number of connected vehicles, power transmission capacity, and power reception capacity with each other. The connection status information is stored for each region.

In the period, a period when the number of connected vehicles and the maximum capacity were aggregated is stored. The period may be a period of one time frame that is a bid unit in the power trading. In the number of connected vehicles, the number of vehicles 30 connected to the charging and discharging facility 20 within the period is stored. When one vehicle 30 is connected to charging and discharging facility 20 across each period, the number of connected vehicles is counted as “one” in each period. When the vehicle is connected to the charging and discharging facility 20 only during a partial period within each period, a value obtained by dividing the time of the period when the vehicle is connected to the charging and discharging facility 20 by the time of each period is counted as the number of connected vehicles in each period.

In the power transmission capacity, a total value of capacity in which each vehicle 30 connected to the charging and discharging facility 20 is capable of transmitting power towards the charging and discharging facility 20 is stored. The power transmission capacity may be aggregated based on the lower capacity of the maximum power transmission capacity of the battery 32 and the maximum power transmission capacity from the charging and discharging facility 20 to the power grid 10. When the charging and discharging facility 20 has no function of supplying power to the power grid 10, the capacity of the vehicle 30 connected to that charging and discharging facility 20 is not included in the power reception capacity. Note that when the SOC of the battery 32 of the vehicle 30 is lower than a first reference value as a power transmission allowable condition, the capacity of that vehicle 30 is not included in the power transmission capacity.

In the power reception capacity, a total value of capacity in which each vehicle 30 connected to the charging and discharging facility 20 is capable of receiving power from the charging and discharging facility 20 is stored. The power reception capacity may be aggregated based on the lower capacity of the maximum power reception capacity of the battery 32 and the maximum power transmission capacity from the charging and discharging facility 20 to the battery 32. Note that when the SOC of the battery 32 of the vehicle 30 is higher than a second reference value as a power reception allowable condition, the capacity of that vehicle 30 may not included in the power reception capacity.

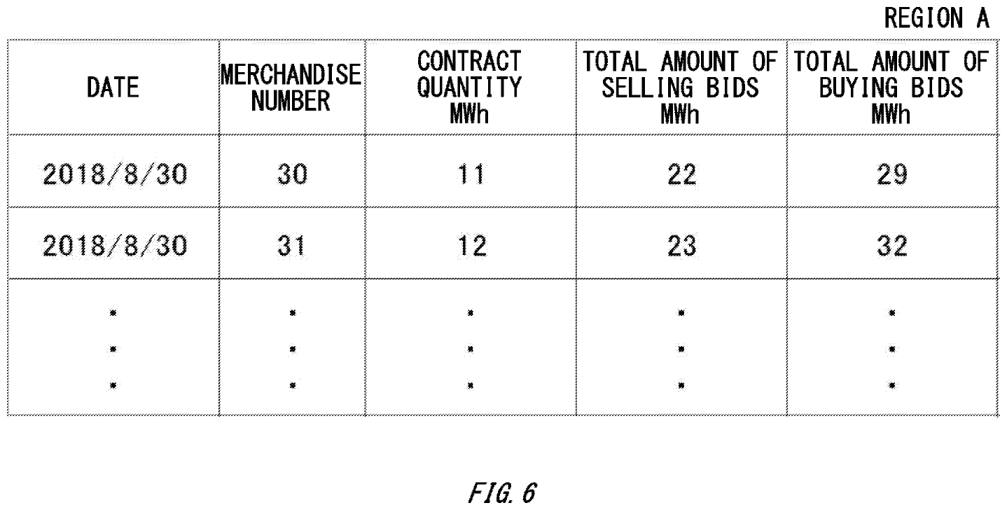

FIG. 6 illustrates in a form of table an example of power trading information. The power trading information is stored in the demand information storage unit 286. The power trading information associates the date, a merchandise number, a contract quantity, a total amount of selling bids, and a total amount of buying bids with each other. The power trading information is stored for each power trading market. For example, when the power trading is performed for each region in charge, the power trading information is stored for each region.

In the date, a date of a trading day is stored. In the merchandise number, an identification number of power merchandise to be traded is stored. In the contract quantity, a total value of amount of power contracted is stored. In the total amount of selling bids, a total value of each amount of power bidded to sell is stored. In the total amount of buying bids, a total value of each amount of power bidded to buy is stored. Note that when the bid is performed for each time frame of 30-minute, one power merchandise is set to one time frame. Thus, based on the merchandise number and the date, a period associated with a time frame can be identified.

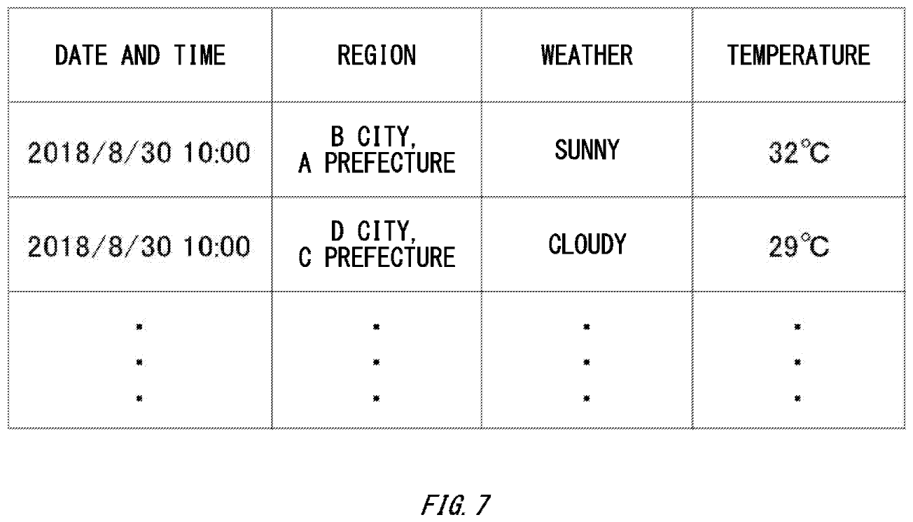

FIG. 7 illustrates in a form of table an example of weather information. The weather information is stored in the environmental information storage unit 288. The weather information associates the date and time, a region, weather, and temperature with each other.

In the date and time, a date and time when weather data including the region, the weather, and the temperature was obtained is stored. The weather data may be obtained, for example, every an hour. In the region, identification information identifying a region is stored. In the weather, identification information of a weather category is stored. In the temperature, a measured value of temperature is stored.

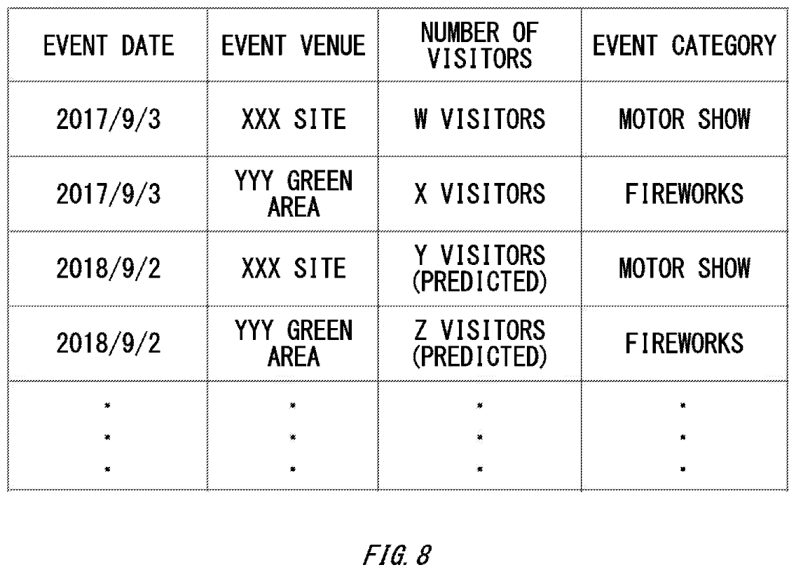

FIG. 8 illustrates in a form of table an example of event information. The event information is stored in the environmental information storage unit 288. The event information associates an event date, an event venue, the number of visitors, and an event category with each other.

In the event date, a date or period when an event was held is stored. In the event venue, identification information of an event venue where an event was held is stored. In the number of visitors, the number of visitors to an event is stored. In the event category, identification information of an event category is stored. The event date, the event venue, and the number of visitors may be obtained from an operating company of the event, an organizer, or the like. Also, the event information includes information on an event to be held in future. In the number of visitors of the event to be held in future, a predicted value of the number of visitors may be stored.

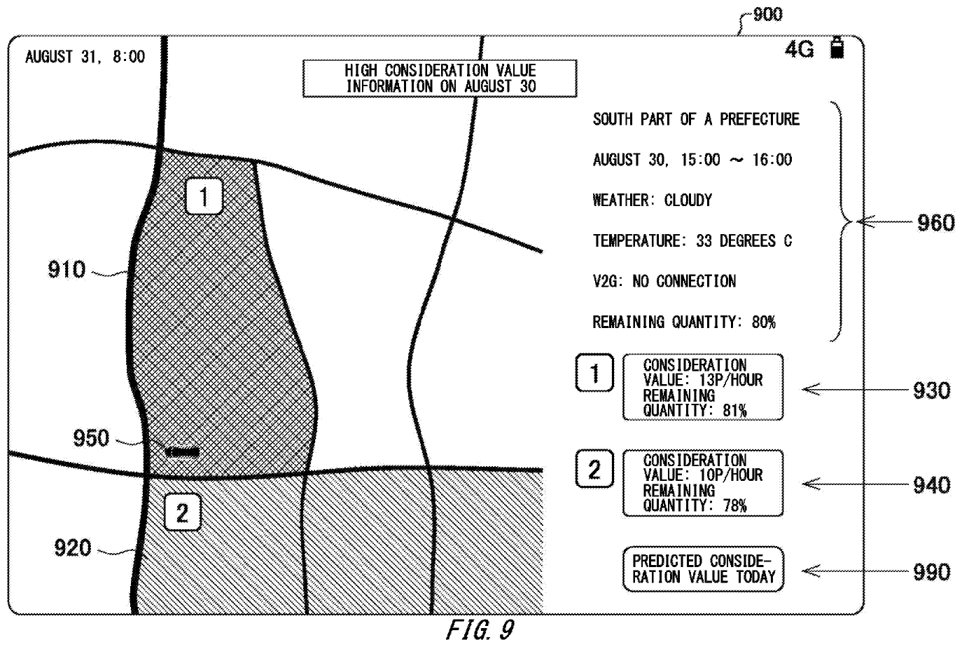

FIG. 9 illustrates an example of a screen 900 displaying power transmission and reception information to the user terminal 82. The screen 900 is displayed to the user terminal 82 by transmitting the power transmission and reception information to the user terminal 82 by the notification control unit 220 of the management server 40. The notification control unit 220 transmits, for example, the power transmission and reception information on the previous day to the user terminal 82. The user terminal 82 displays, at a predetermined time on the next day, the power transmission and reception information on the previous day. For example, the user terminal 82 may display, in the morning on the next day, the power transmission and reception information on the previous day.

The area identification unit 240 identifies the position of the vehicle 30, the area where the vehicle 30 was located, the period when the vehicle 30 was located in that area, and the SOC of the battery 32, based on the traveling record information on the previous day of the vehicle 30. The notification control unit 220 obtains a consideration value given to another user 80 for each combination between an area identified by the area identification unit 240 and a target period, based on the power transmission and reception record information.

Specifically, the notification control unit 220 obtains the only data, of the data stored in the power transmission and reception record information, meeting all the following conditions: the connection period includes the target period, the consideration value is larger than or equal to the predetermined value, and data is associated with the SOC whose difference from the SOC of the battery 32 of the vehicle 30 is within a predetermined range. The notification control unit 220 determines a consideration value given to another user 80 and an SOC, by calculating an average of consideration values included in the obtained data and an average of SOCs, for each combination between an area identified by the area identification unit 240 and a target period.

Also, the notification control unit 220 obtains weather and temperature in the target period from the weather information. Also, the notification control unit 220 identifies whether the vehicle 30 had been connected to the power grid 10 during the target period, based on the traveling record information. The notification control unit 220 transmits to the user terminal 82 the power transmission and reception information including: the area identified by the area identification unit 240 and the target period; the position of the vehicle 30; the weather and the temperature; the state of connection to the power grid 10; the SOC of the battery 32; the average of consideration values given to another user 80; and the average of the SOC of the vehicle 30 of another user 80.

The user terminal 82 displays the screen 900 based on the received power transmission and reception information. On the screen 900, the following are overlaid and displayed on the map: an object 960 indicating a region, a date and time, weather, and temperature; objects 910 and 920 indicating areas where the consideration values were higher than the reference value; objects 930 and 940 indicating the consideration value and the SOC corresponding to each area; and an object 950 indicating the position of the vehicle 30 of the user 80.

It can be seen from the screen 900 that the user 80 was in the region where the consideration value was high between 15:00 and 16:00 on the previous day, but did not connect the vehicle 30 with the V2G connection. Also, it can be seen that the consideration value was high in the area indicated by the objects 910 and 920 when the environment was as indicated by the object 960. By repeatedly transmitting such power transmission and reception information to the user 80, the user 80 can learn when and at what timing a high consideration value can be obtained by the V2G connection.

Note that, on the screen 900, an object 990 is displayed, which receives an instruction making today's consideration value information displayed. When the object 990 is pushed, a screen displaying a predicted consideration value on the day is displayed.

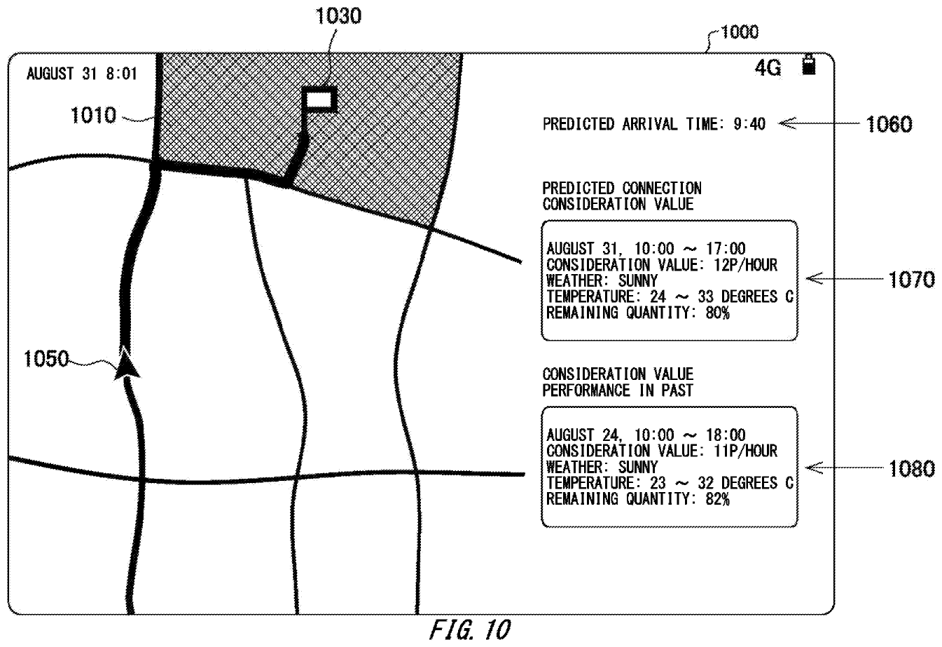

FIG. 10 illustrates an example of a screen 1000 for displaying a predicted consideration value on the day. The screen 1000 is displayed on the user terminal 82, by transmitting predicted consideration value information to the user terminal 82 by the management server 40. The predicted consideration value information is transmitted from the management server 40 to the user terminal 82, in response to receiving request information requesting to display the predicted consideration value on the day from the user terminal 82. For example, the predicted consideration value information is transmitted from the management server 40 to the user terminal 82 when the object 990 on the screen 900 is pushed.

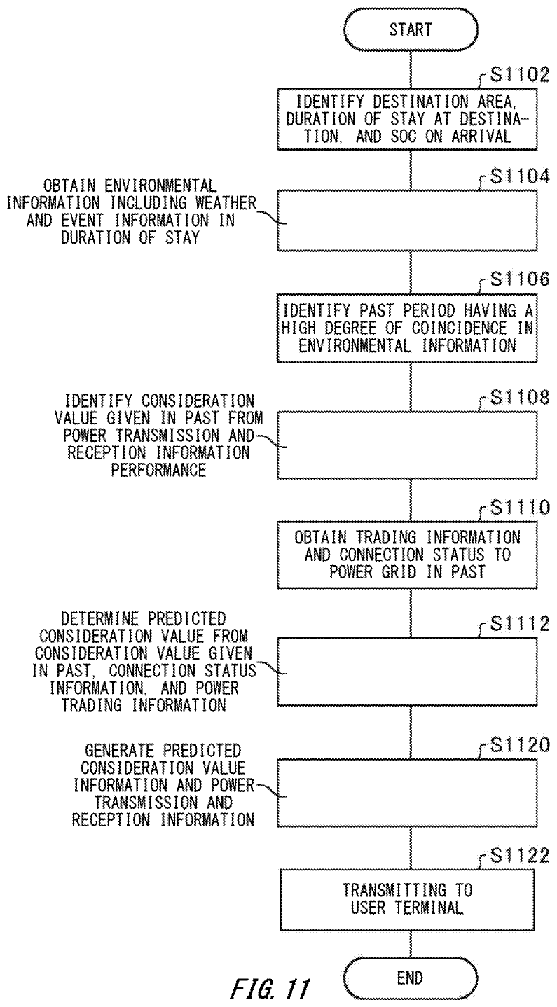

The predicted consideration value information includes a predicted period where the user 80 will stay within the area, a consideration value obtained by connecting the vehicle 30 to the power grid 10 during the period of stay, weather forecast information, and information indicating the SOC of the vehicle 30. Also, the management server 40 transmits, along with the predicted consideration value information, power transmission and reception performance information in a corresponding period in past. The predicted consideration value information and the power transmission and reception performance information are described in reference to FIG. 11.

The user terminal 82 displays the screen 1000 based on the received predicted power transmission and reception information. The screen 1000 shows a screen when the user terminal 82 displays a navigation view of the vehicle 30. On the screen 1000, the following are overlaid and displayed on the map: an object 1050 indicating the current position of the vehicle 30; an object 1030 indication a destination; an object 1010 indicating an area including the destination; an object 1060 indicating an arrival time; an object 1070 indicating a predicted consideration value to be given to the user 80; and an object 1080 indicating a consideration value given to another user 80 in a corresponding period in past. The object 1070 includes a predicted consideration value per hour to be given when the user 80 connects the vehicle 30 to the power grid 10 during the period of staying in the destination.

The user 80 can know, from the screen 1000, a predicted value of a consideration value to be obtained by performing the V2G connection within the period of staying in the destination area by the user 80, and a performance value of a consideration value given to another user 80 in past. This enables the user 80 to determine whether high consideration value is obtained if the V2G connection is performed in having arrived at the destination.

FIG. 11 is a flow chart illustrating processes for a management server 40 to generate predicted power transmission and reception information and power transmission and reception performance information. The flow chart in FIG. 11 is mainly performed by the processing unit 42 of the management server 40. The processes of the flow chart in FIG. 11 start, for example, when the management server 40 receives request information requesting to display a predicted consideration value on the day from the user terminal 82.

In S1102, the area identification unit 240 identifies respective predicted values of the following: a destination area of the vehicle 30, a predicted period of stay where the user 80 will stay in the destination, and the SOC on arrival of the battery 32. For example, the area identification unit 240 identifies the destination area and the period of stay, based on the destination and the arrival time of the vehicle 30 included in the received request information from the user terminal 82 and data stored in the traveling record information. Also, the notification control unit 220 identifies the SOC on arrival of the battery 32, based on the distance from the current position of the vehicle 30 to the destination area, the current SOC of the battery 32, and electricity consumption information of the vehicle 30 calculated from the traveling record information.

In S1104, the value determination unit 250 obtains weather forecast information of the destination area during the period of stay. Also, the value determination unit 250 obtains event information of the destination area is past and on the day. In S1106, the value determination unit 250 identifies a past period when a degree of coincidence with the weather information and the event status in the destination area is high, based on the weather forecast information and the event information obtained in S1104 and past weather information stored in the environmental information storage unit 288. Note that, for the degree of coincidence with the event status, the degree of coincidence may be determined as high, when a kind of the event to be held is the same and a difference between the number of visitors in past and the predicted number of visitors is in the predetermined range.

In S1108, the value determination unit 250 obtains, of the data stored in the power reception performance information, data of the power transmission and reception performance information performed, in the destination area, between the power grid 10 and other vehicle 30 during a period corresponding to the period identified in S1106. At the time, the value determination unit 250 obtains only data that is associated with a SOC that the difference from the SOC identified in S1102 is in the predetermined range. Then, the value determination unit 250 identifies a consideration value given in past, by calculating an average of the consideration values included in the obtained data.

In S1110, the value determination unit 250 obtains, based on the connection status information, in the destination area, the number of connected vehicles in period corresponding to the period identified in S1106 and the power transmission capacity and the power reception capacity. Also, the value determination unit 250 obtains, based on the power trading information, in the destination area, a contract quantity corresponding to the period identified in S1106 and information on the total amount of selling bids and the total amount of buying bids.

In S1112, the value determination unit 250 determines the predicted consideration value, based on the following: the past consideration value identified in S1108; the number of connected vehicles, the power transmission capacity, and the power reception capacity obtained in S1112; and the contract quantity, the total amount of selling bids, and the total amount of buying bids. For example, the value determination unit 250 determines, with respect to the past consideration value identified in S1108, the predicted consideration value by adjusting the consideration value based on the information obtained in S1110. For example, the value determination unit 250 makes the predicted consideration value higher as the number of connected vehicles is smaller. The value determination unit 250 makes the predicted consideration value higher as the power transmission capacity is smaller. The value determination unit 250 makes the predicted consideration value higher as the power reception capacity is smaller. The value determination unit 250 makes the predicted consideration value higher as the contract quantity is larger. Also, the value determination unit 250 makes the predicted consideration value higher as the total amount of buying bids of power is larger or as the total amount of selling bids is smaller. The value determination unit 250 may determine the amount of adjustment to the past consideration value, based on a ratio the total amount of buying bids and the total amount of selling bids of power.

In S1120, The notification control unit 220 generates predicted consideration value information including the predicted consideration value determined in S1112, the period of stay and weather information in the destination area, and the SOC of the battery 32. Also, the notification control unit 220 generates power transmission and reception performance information including the period identified in S1106 and weather information in that period, the past consideration value identified in S1108, and the average of SOCs. In S1122, the predicted consideration value information and power transmission and reception performance information generated in S1120 are transmitted to the user terminal 82.

According to the process, the consideration value to be obtained by performing the V2G connection in the destination area by the user 80 and the performance value of the past consideration value can be accurately notified the user 80.

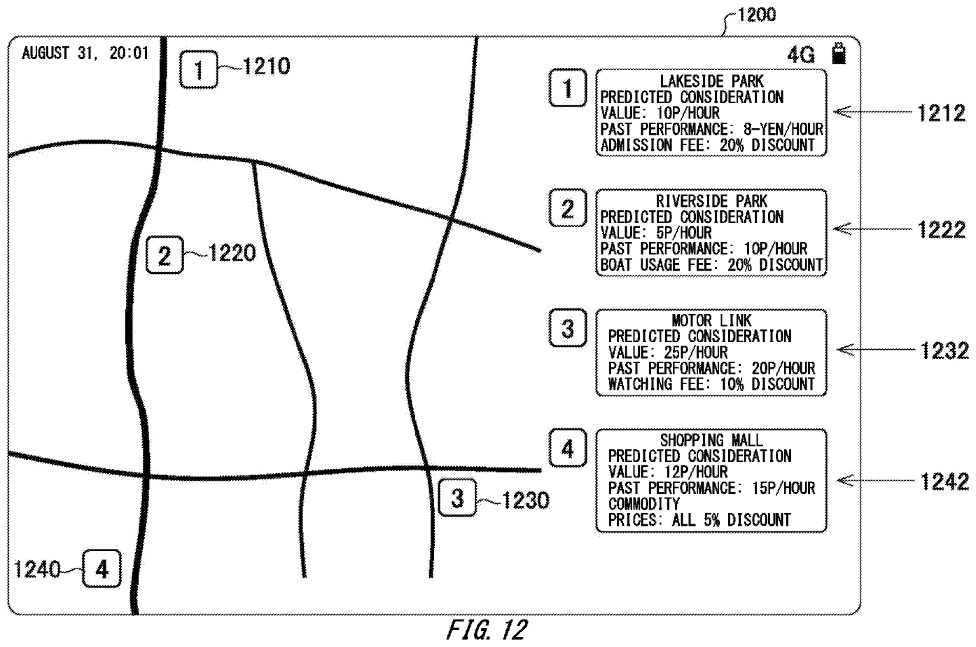

FIG. 12 illustrates an example of a screen 1200 displayed when a user 80 searches for destinations by keyword searching. The screen 1200 is displayed when the user terminal 82 receives candidate site information from the management server 40. The candidate site information is transmitted from the management server 40 to the user terminal 82, in response to having performed a keyword searching by the user 80 in the user terminal 82.

For example, when the user 80 input keywords, such as “walk, race, shopping”, into the user terminal 82 in determining destinations and waypoints to be visited in the weekend, the user terminal 82 transmits the inputted keywords to the management server 40. The management server 40 is to: search for, based on the received keywords, one or more destination candidates on the basis of preference information of the user 80; generate the candidate site information including a predicted consideration value to be obtained in each candidate site, past consideration values indicating consideration values given in past, and privilege information available in each candidate site; and transmit it to the user terminal 82.

Specifically, the area identification unit 240 identifies recommended candidate sites as a destinations or waypoints, based on the received keywords. For example, the area identification unit 240 extracts one or more candidate sites from among areas associated with the received keywords, taking account of the vehicle position referred from the traveling record information, and the preference information of the user stored in the user information storage unit 284. Then, The management server 40 generates the predicted consideration value information and the power transmission and reception performance information on each candidate site by performing processes similar to ones from S1102 to S1120 in FIG. 11, and transmits them as candidate site information to the user terminal 82. Note that the notification control unit 220 may transmit to the user terminal 82 only candidate site information on candidate sites whose predicted consideration values exceed the predetermined value.

The user terminal 82 displays the screen 1200 based on the received candidate site information. On the screen 1200, the following are overlaid and displayed on the map information: objects 1210, 1 220, 1230, and 1240 indicating positions of the candidate sites; and objects 1212, 1222 1232, and 1242 indicating names, predicted consideration values, past consideration values, and privilege information of the respective candidate sites.

The user 80 can determine the destinations and waypoints from the screen 1200, taking account of not only privileges obtained in the respective candidate sites but also further predicted consideration values obtained when the V2G connection is performed. For example, not only discount information available at the commercial facility 150 such as the shopping mall but also the predicted consideration values can be provided to the user 80, so that it is possible to prompt the user 80 to go to a farther shopping mall than nearby stores that the user 80 regularly use. Also, even when the user 80 wants to go for a walk to a park, it is possible to prompt the user 80 to go to a farther park than the park where the user 80 regularly goes. Also, it is possible to prompt the user 80 to use the vehicle 30 to go to a place where the user 80 usually goes by train. In this way, the management server 40 provides the predicted consideration value information with the user 80, so that the user 80 can select the destination and waypoint, also taking account of the consideration value information.

As described above, according to the power transmission and reception management system 100, it is possible to notify the user 80 of; the performance information of the consideration value obtained in past by the V2G connection in the behavioral area of the user 80; and the predicted consideration value to be obtained when the V2G connection is performed in a future behavioral area of the user 80. This enables the user 80 to be prompted to perform the V2G connection when power demand by the V2G is high. This enables the power aggregator to easily secure the capacity capable of transmitting and receiving power between vehicle 30 and the power grid 10, thus to contribute to stabilizing power supply and demand in power grid 10.

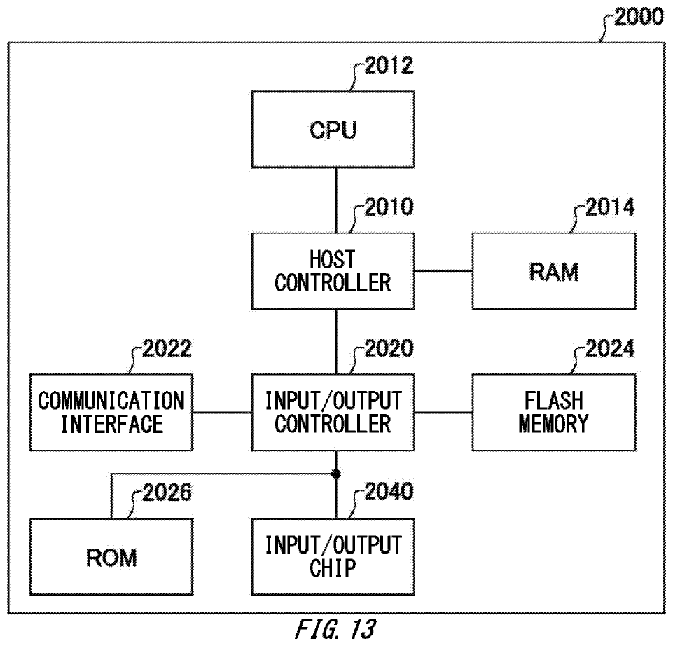

FIG. 13 illustrates an example of a computer 2000 in which a plurality of embodiments of the present invention may be entirely or partially embodied. A program installed in a computer 2000 can cause the computer 2000 to function as a device such as the management server 40 according to the embodiments or each unit of the device, to perform operations associated with the device or each unit of the device, and/or to perform processes according to the embodiments or steps of the processes. Such a program may be executed by a CPU 2012 in order to cause the computer 2000 to execute a specific operation associated with some or all of the blocks in the process procedure and the block diagram described in the specification.

The computer 2000 according to this embodiment includes the CPU 2012 and RAM 2014, which are connected mutually by a host controller 2010. The computer 2000 also includes a ROM 2026, a flash memory 2024, a communication interface 2022, and an input/output chip 2040. The ROM 2026, the flash memory 2024, the communication interface 2022 and the input/output chip 2040 are connected to the host controller 2010 via an input/output controller 2020.

The CPU 2012 operates according to the program stored in the ROM 2026 and the RAM 2014, thereby controlling each unit.

The communication interface 2022 communicates with other electronic devices via a network. The flash memory 2024 stores the program and data used by the CPU 2012 in the computer 2000. The ROM 2026 stores a boot program or the like executed by the computer 2000 during activation, and/or a program depending on hardware of the computer 2000. The input/output chip 2040 may also connect, to the input/output controller 2020, a variety of input/output unit such as a keyboard, a mouse, and a monitor, via input/output ports such as a serial port, a parallel port, a keyboard port, a mouse port, a monitor port, a USB port, and HDMI (registered trademark) port.

The program is provided via a network or a computer-readable medium such as a CD-ROM, a DVD-ROM, or a memory card. The RAM 2014, the ROM 2026, or the flash memory 2024 is an example of the computer-readable medium. The program is installed in the flash memory 2024, the RAM 2014 or the ROM 2026 and executed by the CPU 2012. Information processing described in the program is read by the computer 2000, thereby resulting in cooperation between the program and above-described various types of hardware resources. An device or method may be constituted by implementing the operations or processing on information according to the use of the computer 2000.

For example, when communications are performed between the computer 2000 and external devices, the CPU 2012 may execute a communication program loaded in the RAM 2014, and instruct the communication interface 2022 to execute communication processing on based on the processes written in the communication program. The communication interface 2022, under the control of the CPU 2012, reads out transmission data stored in a transmission buffer processing area provided in a recording medium such as the RAM 2014 and the flash memory 2024, transmits the read transmission data to the network, and writes a reception data received from the network into a reception buffer processing area or the like provided on the recording medium.

Also, the CPU 2012 may cause all or required portions of a file or a database stored in the recording medium such as the flash memory 2024 to be read by the RAM 2014, and perform various kinds of processes on the data on the RAM 2014. The CPU 2012, then, writes back the processed data into the recording medium.

Various types of programs and various types of information such as data, tables, and databases may be stored in the recording medium, and they may be performed information processing on. The CPU 2012 may perform, on the data read from the RAM 2014, various kinds of processing including various kinds of operations, information processing, conditional judgments, conditional branching, unconditional branching, information searching/replacing and the like described in the specification and specified by an instruction sequence of the program, and writes back the result into the RAM 2014. Also, the CPU 2012 may search for information in a file, a database, etc., in the recording medium. For example, when a plurality of entries each having an attribute value of a first attribute respectively associated with an attribute value of a second attribute is stored in the recording medium, the CPU 2012 may search for, from among the plurality of entries, an entry in which the attribute value of the first attribute is specified and that match with a condition, read the attribute value of the second attribute stored in the entry, and thereby obtain the attribute value of the second attribute associated with the first attribute meeting a predetermined condition.

The program or software module described above may be stored on the computer 2000 or in a computer-readable medium near the computer 2000. The recording medium such as a hard disk or RAM provided in a server system connected to a dedicated communication network or the internet is available as a computer-readable medium. The program stored in the computer-readable medium may be provided to the computer 2000 via the network.

The program that is installed in the computer 2000 and that causes the computer 2000 to function as the management server 40 may act on the CPU 2012 etc. to cause the computer 2000 to function respectively as each unit of the management server 40. Information processing described in the program functions as the notification control unit 220, the area identification unit 240, the value determination unit 250, the consideration value control unit 270, the power transmission and reception control unit 280, the demand information obtaining unit 290, etc. that are concrete means in which software and above-described various hardware resources cooperate by loaded into the computer 2000. Then, by these concrete means, the distinctive management server 40 depending on the intended use is constructed by realizing operation or processing of information depending on the intended use of the computer 2000 in this embodiment.

A variety of embodiments have been described with reference to the block diagram and the like. In the block diagram, each block may represent (1) a step of a process in which an operation is performed, or (2) each unit of the device having a role of performing the operation. Specific steps and each unit may be implemented by a dedicated circuit, a programmable circuit provided along with a computer-readable instruction stored on a computer-readable medium, and/or a processor provided along with the computer-readable instruction stored on the computer-readable medium. The dedicated circuit may include a digital and/or analog hardware circuit, or may include an integrated circuit (IC) and/or a discrete circuit. The programmable circuit may include a reconfigurable hardware circuit including: logical AND, logical OR, exclusive OR (XOR), negative AND (NAND), negative OR (NOR), and other logical operation; and a memory element such as a flip-flop, a register, a field programmable gate array (FPGA), a programmable logic array (PLA); and so on.

The computer-readable medium may include any tangible device capable of storing an instruction executed by an appropriate device, so that the computer-readable medium having the instruction stored thereon constitutes at least a part of a product including the instruction that may be executed in order to result in a means for executing an operation specified by a processing procedure or a block diagram. Examples of the computer-readable medium may include an electronic storage medium, a magnetic storage medium, an optical storage medium, an electromagnetic storage medium, a semiconductor storage medium, etc. More specific examples of the computer-readable medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disc (DVD), a Blu-ray (registered trademark) disc, a memory stick, an integrated circuit card, etc.

Computer-readable instructions may include any of source code or object code written in any combination of one or more programming languages including: assembler instructions, instruction-set-architecture (ISA) instructions, machine instructions, machine dependent instructions, microcode, firmware instructions, state-setting data; or object oriented programming languages such as Smalltalk, Java (registered trademark), C++, etc.; and conventional procedural programming languages such as the “C” programming language or similar programming languages.

Computer-readable instructions may be provided to a general-purpose computer, a special-purpose computer, or a processor or a programmable circuit of other programmable data processing device, locally or via a local area network (LAN), a wide area network (WAN) such as the internet, and computer-readable instructions may be executed in order to result in a means for executing operations specified by the described processing procedure or the block diagram. Examples of processors include computer processors, processing units, microprocessors, digital signal processors, controllers, microcontrollers, etc.

While the present invention has been described above with the embodiments, the technical scope of the invention is not limited to the scope according to the above described embodiments. It is apparent to persons skilled in the art that various alterations or improvements can be added to the above-described embodiments. Also, unless a technical contradiction occurs, the matters described in a specific embodiment can be applied to another embodiment. It is also apparent from the scope of the claims that the embodiments added with such alterations or improvements can be included in the technical scope of the invention.

The operations, procedures, steps, stages, and the like of each process performed by a device, system, program, and method shown in the claims, the specification, or drawings can be performed in any order as long as the order is not indicated by “prior to,” “before,” or the like and as long as the output from a previous process is not used in a later process. Even if the operation flow is described using phrases such as “first” or “next” in the claims, the specification, or drawings, it does not necessarily mean that the process must be performed in this order.

### EXPLANATION OF REFERENCES

10: power grid, 12: power generating facility, 14: stationary battery, 20: charging and discharging facility, 22: charging and discharging cable, 30: vehicle, 32: battery, 40: management server, 42: processing unit, 46: communication unit, 48: storage unit, 50: power trading server, 80: user, 82: user terminal, 100: power transmission and reception system, 150: commercial facility, 220: notification control unit, 240: area identification unit, 250: value determination unit, 270: consideration value control unit, 280: power transmission and reception control unit, 290: demand information obtaining unit, 282: vehicle information storage unit, 284: user information storage unit, 286: demand information storage unit, 288: environmental information storage unit, 900: screen, 910, 920, 930, 940, 950, 960, 990: object, 1000: screen, 1010, 1030, 1050, 1060, 1070, 1080: object, 1200: screen, 1210, 1212, 1220, 1222, 1230, 1232, 1240, 1242: object, 2000: computer, 2010: host controller, 2012: CPU, 2014: RAM, 2020: input/output controller, 2022: communication interface, 2024: flash memory, 2026: ROM, 2040: input/output chip

What is claimed is:

1. A control device comprising:
an area identification unit for identifying a behavioral area of a user associated with a vehicle equipped with an electric power source for driving; and
a notification control unit for making the user notified power transmission and reception information indicating past performance of power transmission and reception performed between the vehicle associated with another user in the behavioral area and a power grid.

2. The control device according to claim 1, wherein the power transmission and reception information includes information indicating a value of the power transmission and reception.

3. The control device according to claim 2, wherein the notification control unit makes the user notified on condition that the value of the power transmission and reception is higher than a predetermined value.

4. The control device according to claim 3, wherein the notification control unit makes the user notified on condition that, during a period when the user did not enable the vehicle to perform the power transmission and reception to and from the power grid, the value of the power transmission and reception in an area where the vehicle was located is higher than the predetermined value.

5. The control device according to claim 2, wherein the information indicating the value of the power transmission and reception includes at least any of information indicating a consideration value, on having performed the power transmission and reception, provided to the other user or the vehicle associated with the other user, or information indicating a connection status, against a power demand amount of the power grid, of the vehicle connected to be capable of performing the power transmission and reception to and from the power grid.

6. The control device according to claim 2, wherein the power transmission and reception information include information indicating a period when the power transmission and reception was performed.

7. The control device according to claim 1, wherein the notification control unit displays, on a user terminal that the user uses, the power transmission and reception information, along with a position on a map of the behavioral area where the power transmission and reception was performed.

8. The control device according to claim 1, further comprising:
an environmental information storage unit for storing environmental information in the behavioral area when the power transmission and reception was performed; and
a value determination unit for determining a value on performing, currently or in future within the behavioral area, the power transmission and reception between the vehicle associated with the user and the power grid, based on the environmental information of the behavioral area when the power transmission and reception was performed and current or future environmental information within the behavioral area,
wherein the notification control unit further makes the user notified of information indicating a value determined by the value determination unit.

9. The control device according to claim 8, wherein the environmental information of the behavioral area when the power transmission and reception was performed includes information indicating at least any of; weather in the behavioral area when the power transmission and reception was performed; an event that was held within the behavioral area when the power transmission and reception was performed.

10. The control device according to claim 8, wherein the notification control unit makes the user notified information indicating the power transmission and reception information and the value, on condition that the value that the value determination unit has determined is higher than a predetermined value.

11. The control device according to claim 1, wherein the area identification unit identifies the behavioral area based on at least any of; a traveling record of the vehicle; destination information specified by the user; preference information of the user; keyword information inputted by the user; a position of the user or the vehicle; and home location of the user.

12. The control device according to claim 1, wherein the electric power source for driving is a battery.

13. A non-transitory computer-readable storage medium having a program stored thereon, the program causing a computer to function as:
an area identification unit for identifying a behavioral area of a user associated with a vehicle equipped with an electric power source for driving; and
a notification control unit for making the user notified power transmission and reception information indicating past performance of power transmission and reception performed between the vehicle associated with another user in the behavioral area and a power grid.
